(19) United States
(12) Patent Application Publication
(10) Pub. No.: US 2024/0246003 A1
(43) Pub. Date: Jul. 25, 2024

(54) FUSIBLE TOY BEAD

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 18/415,982

(22) Filed: Jan. 18, 2024

(30) Foreign Application Priority Data
Jan. 20, 2023 (JP) 2023-007557

(51) Int. Cl. A63H 33/00

(52) U.S. Cl. CPC A63H 33/001

(57) ABSTRACT

A fusible toy bead is formed by blending a pigment serving as a colorant into a water-soluble resin. The fusible toy bead includes a surface. The surface includes: a textured region having a textured surface with irregularities; and a smooth region having a smooth surface. The textured region has a texturing depth such that the textured surface is smoothed when the irregularities dissolve in water.

### CROSS-REFERENCE TO RELATED APPLICATIONS

This application is based on and claims priority under 35 USC 119 from Japanese Patent Application No. 2023-007557 filed on Jan. 20, 2023, the contents of which are incorporated herein by reference.

### TECHNICAL FIELD

The present disclosure relates to a fusible toy bead.

### BACKGROUND ART

Today, there are toys called toy beads, in which beads such as small resin spheres or tubular bodies are fused together to create various decorations. For example, JP2013-143986A discloses a fusible toy bead in which beads can be fused together simply by spraying a liquid such as water to create bead combinations of various shapes.

### SUMMARY OF INVENTION

In the fusible toy bead disclosed in JP2013-143986A, decorations can be created by taking out beads from a storage case or the like that stores a plurality of beads and arranging the beads. However, the beads have smooth surfaces, and thus it may be difficult to pick the beads and take out the beads from the storage case or the like. On the other hand, when a part of the surface of the bead is cut or the like to make the bead easy to pick, ease of play may be impaired.

An object of the present disclosure is to provide a fusible toy bead that is easy to be taken out from a storage case or the like.

The present disclosure provides a fusible toy bead formed by blending a pigment serving as a colorant into a water-soluble resin, the fusible toy bead including: a surface, the surface including: a textured region having a textured surface with irregularities; and a smooth region having a smooth surface, in which the textured region has a texturing depth such that the textured surface is smoothed when the irregularities dissolve in water.

According to the present disclosure, it is possible to provide a fusible toy bead that is easy to be taken out from a storage case or the like.

### BRIEF DESCRIPTION OF DRAWINGS

The present disclosure will be described in detail based on the following without being limited thereto, wherein:

FIG. 1 is a front view of a fusible toy bead according to an embodiment of the present disclosure;

FIG. 2 is a top view of the fusible toy bead according to the embodiment of the present disclosure;

FIG. 3 is a perspective view of a tray on which a plurality of fusible toy beads according to the embodiment of the present disclosure are placed; and

FIG. 4 is a schematic view of a test device used in a drop comparison test of fusible toy beads in an example of the present disclosure.

### DESCRIPTION OF EMBODIMENTS

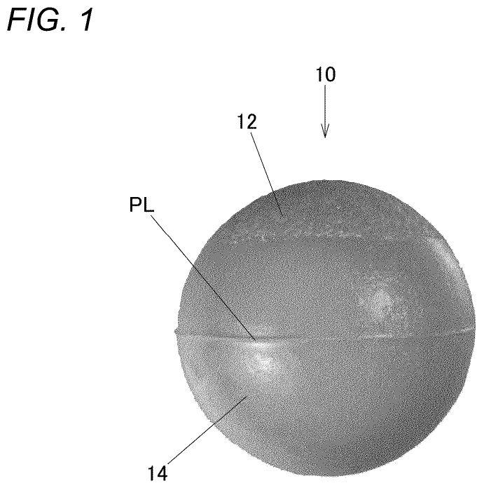

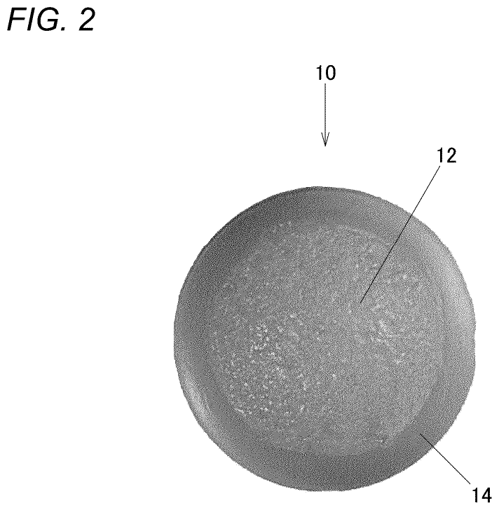

An embodiment of the present disclosure will be described with reference to the drawings. As shown in FIGS. 1 and 2, a fusible toy bead 10 according to the embodiment is spherical and has a particle size of substantially 5 mm. The fusible toy bead 10 is formed by injection molding using a mold, using a colored transparent synthetic resin, which is obtained by blending a plurality of pigments serving as colorants in a water-soluble resin blended with polyvinyl alcohol, as a raw material. When colored with a colorant, the fusible toy bead 10 can have a transparent color exhibiting a color of green, blue, red, yellow, purple, or the like that harmonizes transparency and hue.

A part of a surface of the fusible toy bead 10 is textured. That is, the surface of the fusible toy bead 10 is divided into a textured region 12 subjected to texturing and a smooth region 14 not subjected to texturing. That is, the textured region 12 includes a textured surface with irregularities, and the smooth region 14 includes a smooth surface. Specifically, the textured region 12 is an upper region of the surface of the fusible toy bead 10 and is formed in a region of substantially ¼ of the surface of the fusible toy bead 10.

Since the textured region 12 is provided on the surface of the fusible toy bead 10 as described above, when the fusible toy bead 10 is picked and taken out from a storage case or the like, at least a part of a finger that picks the bead comes into contact with the textured region 12. A part of the textured region 12 that comes into contact with the finger is harder to be separated from the finger than a part of the smooth region 14 that comes into contact with the finger due to a frictional force acting between the textured surface and a surface of the finger. For this reason, the fusible toy bead 10 is easier to be taken out of the storage case or the like than a fusible toy bead in the related art in which the smooth region 14 is formed on an entire surface.

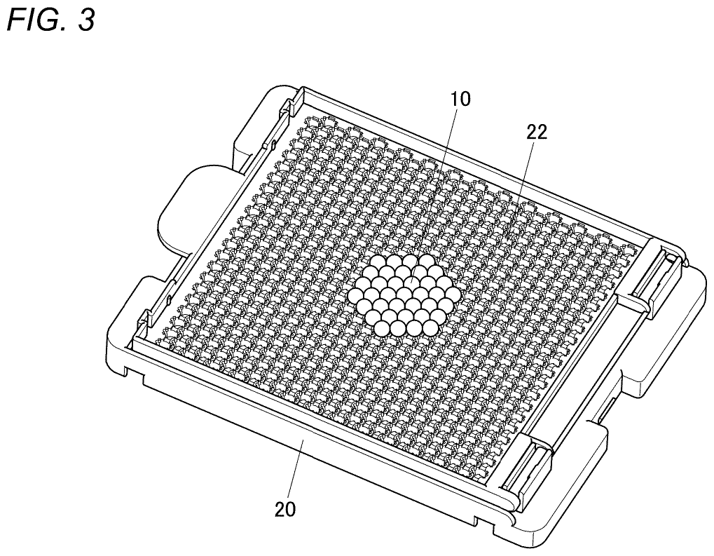

In addition, since the textured region 12 is provided on the surface of the fusible toy bead 10, when a plurality of fusible toy beads 10 are adjacent and arranged in holes 22 on a tray 20 as shown in FIG. 3, for example, a frictional force acts between the textured regions 12 of the adjacent fusible toy beads 10, and thus the fusible toy beads 10 are less likely to displace on the tray 20.

In the fusible toy bead 10, a texturing depth in the textured region 12 is in a range of 35 to 45 μm. Since the fusible toy bead 10 is finely textured in this manner, irregularities on the surface in the textured region 12 due to texturing are dissolved in water when sprayed with water, and the textured region 12 has substantially the same smoothness as the smooth region 14. That is, the textured region 12 changes into the smooth region 14. In other words, the textured surface in the textured region 12 is smoothed. For this reason, ease of play of the fusible toy bead 10 would not be impaired when playing with a combination of the fusible toy beads 10 that is obtained by fusing a plurality of fusible toy beads 10 together.

The fusible toy bead 10 described above can be formed by injection molding using a mold provided with irregularities for texturing in a part thereof. The fusible toy bead 10 is formed with, as shown in FIG. 1, a parting line PL on a line on which the mold is divided in a molding process. The textured region 12 is formed at a portion not overlapping the parting line PL. The portion where the textured region 12 is formed in the molding process is excellent in mold releasability when the mold is released. For this reason, molding time in the molding process can be shortened.

According to the embodiment of the present disclosure described above, it is possible to provide a fusible toy bead according to the following aspects.

A fusible toy bead according to a first aspect is a fusible toy bead formed by blending a pigment serving as a colorant into a water-soluble resin, in which a surface of the fusible toy bead is divided into a textured region subjected to texturing and a smooth region, and the textured region has a texturing depth that changes into the smooth region when irregularities due to the texturing dissolve in water.

According to this configuration, when the fusible toy bead is picked and taken out from a storage case or the like, at least a part of a finger that picks the fusible toy bead comes into contact with the textured region, and a part of the textured region that comes into contact with the finger is harder to be separated from the finger than a part of the smooth region that comes into contact with the finger. For this reason, the fusible toy bead can be easier to be taken out of the storage case or the like than a fusible toy bead in the related art in which the smooth region is formed on an entire surface. Further, the textured region dissolves in water and changes into the smooth region when the fusible toy bead is sprayed with water, and thus ease of play of the fusible toy bead would not be impaired when playing with a combination of the fusible toy beads that is obtained by fusing a plurality of fusible toy beads together.

In the fusible toy bead according to a second aspect, the texturing depth in the textured region is in a range of 35 to 45 μm.

According to this configuration, it is possible to provide a specific value for the fine texturing depth such that the irregularities in the textured region due to the texturing dissolve in water and change into the smooth region when the fusible toy bead is sprayed with water.

In the fusible toy bead according to a third aspect, the textured region is formed in a region of at least ¼ of the surface of the fusible toy bead.

According to this configuration, when the fusible toy bead is picked and taken out from the storage case or the like, at least a part of the finger that picks the fusible toy bead can be made easier to come into contact with the textured region. For this reason, the fusible toy bead can be more easy to be taken out from the storage case or the like.

Although the embodiment of the present disclosure is described above, the present disclosure is not limited to the above embodiment, and various modifications can be made without departing from the gist thereof. For example, in the above embodiment, the textured region is formed in substantially ¼ of the surface of the fusible toy bead. Alternatively, the textured region may be formed in substantially half of the surface of the fusible toy bead, or be formed in substantially half or more of the surface.

### EXAMPLES

In an example, 10 samples (example) of the fusible toy bead 10 each having a textured region on a surface thereof and 10 samples (comparative example) of the fusible toy bead in the related art having no textured region on surfaces thereof (all surfaces were smooth regions) were prepared, and a drop comparison test was performed to verify the releasability.

In each sample of the example, the textured region was formed in a region of ¼ of the surface of the fusible toy bead 10. In addition, in each sample of the example, a texturing depth in the textured region was set at 40 μm in accordance with a model number “YS 1287B” on a texture data sheet manufactured by Yick Sang Metal and Plastic Mould Texturing.

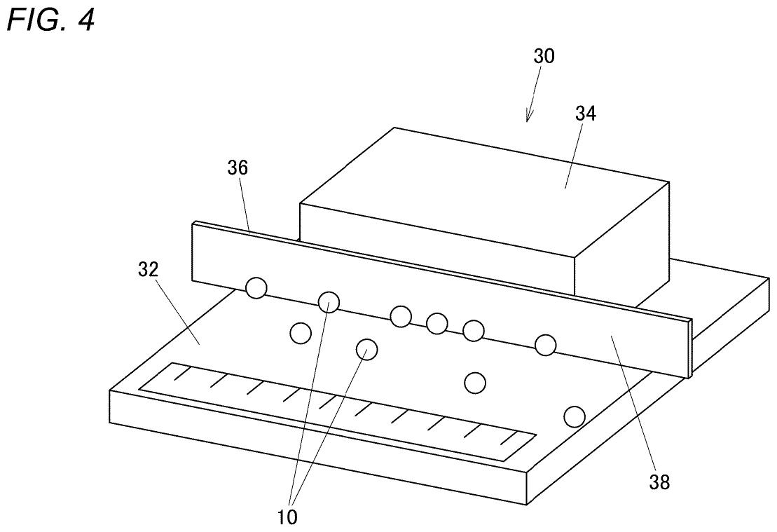

The drop comparison test was performed using a simple test device 30 shown in FIG. 4. As shown in FIG. 4, in the test device 30, a buffer sheet 32 is laid below, an iron weight 34 is placed on the buffer sheet 32, a flat plate 36 is attached to one side surface of the weight, and a tag 38 (general tag that is commercially available) is attached to a surface of the flat plate 36 on a side opposite to the side attached to the weight 34. The tag 38 has an adhesive surface facing outward.

In the drop comparison test, first, 10 samples of the fusible toy bead 10 were arranged in a row on the buffer sheet 32, the weight 34 was lifted in a posture in which the adhesive surface of the tag 38 was directed downward, and the adhesive surface of the tag 38 was pressed against each fusible toy bead 10 from above with a uniform load and each fusible toy bead 10 adhered to the adhesive surface.

Next, as shown in FIG. 4, the weight 34 was placed on the buffer sheet 32 with the adhesive surface directed sideways, and time when the weight 34 was placed was set at zero 15 seconds. The number of seconds until each fusible toy bead 10 was peeled off from the adhesive surface and dropped onto the buffer sheet 32 was counted. The counting started after elapse of one minute. First, each sample of the example was counted for, and then each sample of the comparative example was counted for. In addition, a total of 10 countings (n1 to n10) were repeated for each sample of the example and each sample of the comparative example. Table 1 below shows counting results of each sample of the example, and Table 2 below shows counting results of each sample of the comparative example.

Table 1 is listed below.

TABLE 1

| Number of Samples | Elapse of Time Before Dropped (Second(s)) | | | | | | | | | |
|---|---|---|---|---|---|---|---|---|---|---|
| Dropped | n1 | n2 | n3 | n4 | n5 | n6 | n7 | n8 | n9 | n10 |
| First Dropped Sample | 16 | 0 | 0 | 0 | 0 | 0 | 0 | 0 | 0 | 0 |
| Second Dropped Sample | 17 | 1 | 0 | 0 | 0 | 0 | 0 | 0 | 0 | 0 |
| Third Dropped Sample | 18 | 2 | 1 | 0 | 0 | 0 | 0 | 0 | 0 | 0 |
| Fourth Dropped Sample | 27 | 2 | 2 | 0 | 0 | 0 | 0 | 0 | 0 | 1 |
| Fifth Dropped Sample | 43 | 4 | 3 | 0 | 0 | 0 | 0 | 7 | 0 | 1 |
| Sixth Dropped Sample | 54 | 17 | 8 | 0 | 1 | 0 | 0 | 37 | 3 | 13 |
| Seventh Dropped Sample | 55 | 30 | 16 | 17 | 4 | 37 | 19 | 55 | 3 | 32 |
| Eighth Dropped Sample | — | 54 | 16 | — | 14 | 51 | — | — | 40 | 32 |
| Ninth Dropped Sample | — | — | 16 | — | 14 | 52 | — | — | — | — |
| Tenth Dropped Sample | — | — | 16 | — | — | 60 | — | — | — | — |
| Number of Samples After | 7 | 8 | 10 | 7 | 9 | 10 | 7 | 7 | 8 | 8 |
| Elapse of One Minute | | | | | | | | | | |

TABLE 2

| Number of Samples | Elapse of Time Before Dropped (Second(s)) | | | | | | | | | |
|---|---|---|---|---|---|---|---|---|---|---|
| Dropped | n1 | n2 | n3 | n4 | n5 | n6 | n7 | n8 | n9 | n10 |
| First Dropped Sample | 0 | 5 | 19 | 0 | 0 | 0 | 0 | 0 | 8 | 2 |
| Second Dropped Sample | 10 | 10 | 28 | 0 | 36 | 12 | 0 | 5 | 9 | 13 |
| Third Dropped Sample | 18 | 19 | 28 | 10 | 40 | 33 | 41 | 20 | 9 | 22 |
| Fourth Dropped Sample | 20 | 19 | — | 16 | — | — | — | 28 | 16 | 42 |
| Fifth Dropped Sample | — | 27 | — | — | — | — | — | 43 | 21 | |
| Sixth Dropped Sample | — | 59 | — | — | — | — | — | — | 57 | — |
| Seventh Dropped Sample | — | — | — | — | — | — | — | — | — | — |
| Eighth Dropped Sample | — | — | — | — | — | — | — | — | 1 | — |
| Ninth Dropped Sample | — | — | — | — | — | — | — | — | — | — |
| Tenth Dropped Sample | — | — | — | — | — | — | — | — | — | — |
| Number of Samples After | 4 | 6 | 3 | 4 | 3 | 3 | 3 | 5 | 6 | 4 |
| Elapse of One Minute | | | | | | | | | | |

As shown in Table 1, in the samples of the example, seven to 10 (all) fusible toy beads 10 dropped from the start of the counting to the elapse of one minute in each counting result of 10 times in total. On the other hand, as shown in Table 2, in the samples of the comparative example, three to six fusible toy beads 10 dropped from the start of the counting to the elapse of one minute in each counting result of 10 times in total.

From the above test results, it was confirmed that in the samples of the example, the number of dropped fusible toy beads from the start of counting to the lapse of one minute was significantly larger than that in the samples of the comparative example. From this, it was confirmed that the samples of the example each having the textured region on the surface were excellent in releasability compared to the samples of the comparative example having no textured region on the surfaces.

What is claimed is:

1. A fusible toy bead formed by blending a pigment serving as a colorant into a water-soluble resin, the fusible toy bead comprising:
a surface, the surface comprising:
a textured region having a textured surface with irregularities; and
a smooth region having a smooth surface,
wherein the textured region has a texturing depth such that the textured surface is smoothed when the irregularities dissolve in water.

2. The fusible toy bead according to claim 1, wherein the texturing depth in the textured region is within a range of 35 to 45 μm.

3. The fusible toy bead according to claim 1, wherein the textured region is formed in a region of at least ¼ of the surface.
